(19) United States
(12) Patent Application Publication
(10) Pub. No.: US 2009/0133278 A1
(43) Pub. Date: May 28, 2009

(54) Aerial target template

(76) Inventor: Michael Bonadiman, Beaumont, CA (US)

Correspondence Address: Risso & Associates, 7350 West 85th Street, Los Angeles, CA, 90045, US

(21) Appl. No.: 12/313,454

(22) Filed: Nov. 20, 2008

Related U.S. Application Data
(60) Provisional application No. 60/990,429, filed on Nov. 27, 2007.

(51) Int. Cl. G01B 3/00

(52) U.S. Cl. 33/562

(57) ABSTRACT

An aerial target template for use in marking a ground surface is described. The template comprises a substantially rigid frame that is foldable from a collapsed position to an extended position. When in the extended position, a substantially rectangular-shaped opening is formed and defined by two long legs and two short legs. Two markers are formed on each of the long legs such that when a user paints a first substantially rectangular-shape upon a ground surface, the markers cause distinct markings upon the ground surface. Thus, a user can use the template to paint the first substantially rectangular-shape upon a ground surface and then use the distinct markings to align the two long legs with the distinct markings and paint a second substantially rectangular-shape upon the ground surface, with the first and second substantially rectangular-shapes collectively forming a cross upon the ground surface to operate as the aerial target.

### PRIORITY CLAIM

The present application is a non-provisional patent application, claiming the benefit of priority of U.S. Provisional Application No. 60/990,429, filed on Nov. 27, 2007, entitled, “Aerial Target Template.”

### BACKGROUND OF THE INVENTION

(1) Field of Invention

The present invention relates to an aerial target template and, more specifically, to an aerial target template for use in marking aerial targets upon a ground surface that are recognizable by airborne operators.

(2) Description of Related Art

Aerial targets are markings that are made upon a ground surface and that can be viewed by an operator while airborne. The aerial targets are commonly used by land surveyors, civil engineers, and photogrammetrists to identify particular locations or landmarks from the air. As can be appreciated, in order to operate as an aerial target, the markings must be of a sufficient size to be easily viewable from above. Further, the markings should be consistently shaped to be understood and recognized by a variety of operators.

Historically, surveyors, etc., have used a variety of tools to generate such markings. For example, a surveyor may use a tape measure, a bucket of paint, and a roller to roll out an “X” upon the ground surface. A problem with such a system is that it generates waste through the used rollers, is timely, and will not generate a consistent shape upon the ground surface. Other simple techniques also yield similar problems.

Thus, a continuing need exists for a portable aerial target template that allows a user to easily paint a ground surface with a consistent shape that is commonly recognizable by surveyors, engineers, and photogrammetrists, and that creates a marking that is of a sufficient size to be easily seen while airborne.

### SUMMARY OF INVENTION

The present invention relates to an aerial target template for use in marking aerial targets upon a ground surface that are recognizable by airborne operators. The present invention improves upon the prior art by allowing a user to easily paint a ground surface with a consistent shape and size. Further, the present invention is portable and compact to allow the user to easily transport, deploy, and use the template.

In one aspect, the aerial target template comprises a substantially rigid frame that is foldable from a collapsed position to an extended position. In the extended position, the frame defines a substantially rectangular-shaped opening, with the opening operating as a template to allow a user to paint a substantially rectangular-shape upon a ground surface.

In another aspect, when in the extended position, the substantially rectangular-shaped opening is defined by two long legs and two short legs. Each long leg has a long leg length and each short leg has a short leg length such that a center point exists along the length of each of the two long legs.

Additionally, two markers are formed on each of the long legs. The markers are formed such that when a user paints a first substantially rectangular-shape upon a ground surface, the markers cause distinct markings upon the ground surface. Each marker is positioned along the long leg and away from the center point such that a distance from the center point to each marker is approximately one half of the short leg length. Further, when in the extended position, a distance between the two markers is approximately the same as the short leg length. Thus, a user can use the template to paint the first substantially rectangular-shape upon a ground surface and then use the distinct markings to align the two long legs with the distinct markings and paint a second substantially rectangular-shape upon the ground surface, with the first and second substantially rectangular-shapes collectively forming a cross upon the ground surface to operate as the aerial target.

In another aspect, the marker is selected from a group consisting of a protrusion along the long leg, a notch along the long leg, and a bar positioned perpendicular to the short leg and connecting two opposing long legs.

Furthermore, the frame is formed of a first half hingedly connected with a second half, with the center point delimiting the first half from the second half.

In yet another aspect, the frame is formed of a material selected from a group consisting of aluminum, plastic, iron, wood, carbon fiber, fiberglass and foam.

Finally, as can be appreciated by one in the art, the present invention also comprises a method for forming and using the aerial target template described herein to form the aerial target. The method includes a plurality of acts of forming and using the aerial target template. For example, the method comprises acts of unfolding a substantially rigid frame from a collapsed position to an extended position to define a substantially rectangular-shaped opening (the opening operating as a template to allow a user to paint a substantially rectangular-shape upon a ground surface); positioning the template upon the ground surface; and painting the ground surface through the defined substantially rectangular-shaped opening to form a first substantially rectangular-shape upon the ground surface. Further acts include painting the ground surface such that distinct markings exist upon the ground surface; aligning the substantially rigid frame with the distinct markings; and painting a second substantially rectangular-shape upon the ground surface such that the first and second substantially rectangular-shapes collectively form a cross upon the ground surface to operate as the aerial target.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of an aerial target template according to the present invention, depicting the template folding from an extended position to a collapsed position;

FIG. 2 is an illustration of the aerial target template according to the present invention, depicting the template being used to paint a first substantially rectangular-shape upon a ground surface;

FIG. 3 is an illustration of the aerial target template according to the present invention, depicting the template being used to paint a second substantially rectangular-shape upon the ground surface, with the first and second substantially rectangular-shapes collectively forming a cross upon the ground surface to operate as the aerial target;

FIG. 4A is an illustration of the aerial target template according to the present invention; and

FIG. 4B is an illustration of the aerial target template according to the present invention.

### DETAILED DESCRIPTION

The present invention relates to an aerial target template and, more specifically, to an aerial target template for use in marking aerial targets upon a ground surface that are recognizable by airborne operators. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

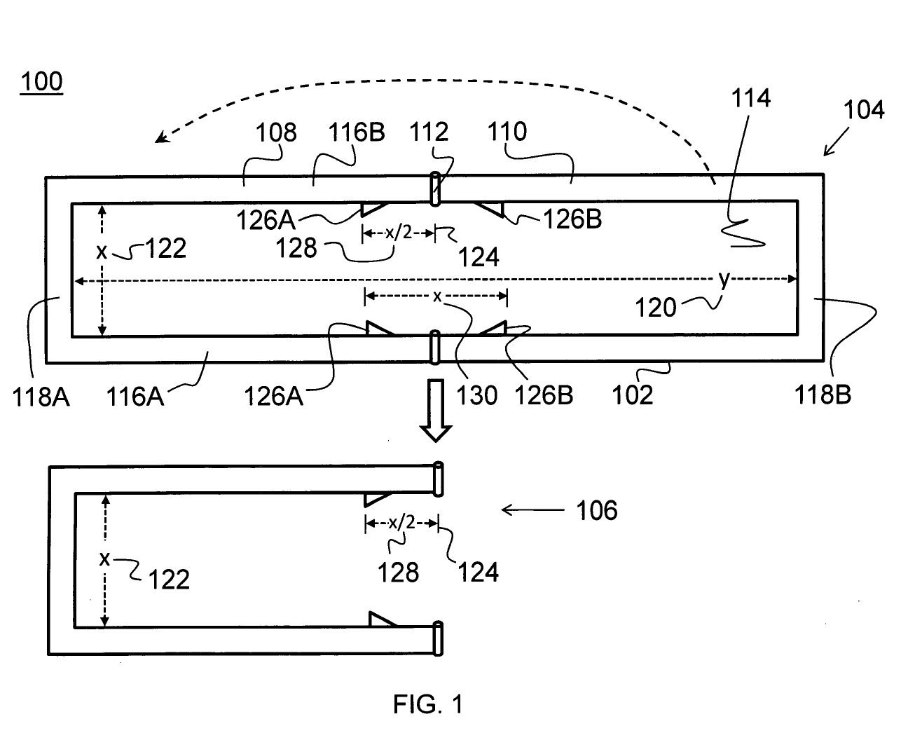

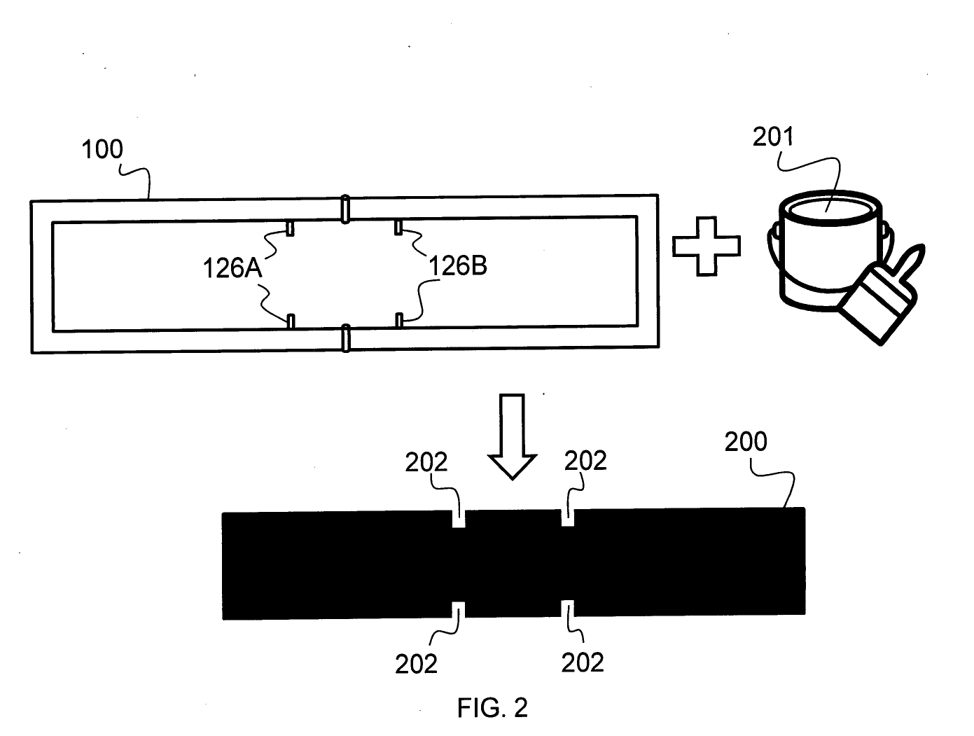

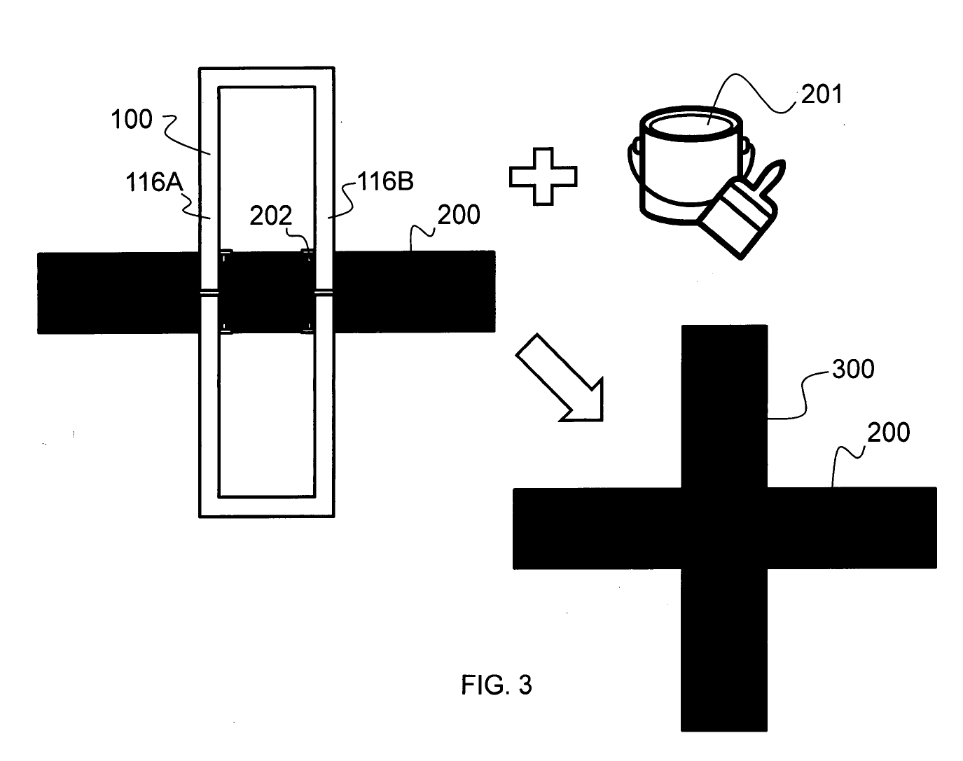

As shown in FIG. 1, the present invention relates to an aerial target template 100 for use in forming aerial targets (depicted in FIGS. 2 and 3) upon a ground surface. The template 100 includes a substantially rigid frame 102 that is foldable between a collapsed position 106 to an extended position 104 (and vice versa; FIG. 1 depicts the frame 102 folding from the extended position 104 into the collapsed position 106). As noted above, the template 100 is formed of a substantially rigid frame 102. The frame 102 is formed of a substantially rigid material to enable the formation of a consistent shape despite repeated uses. More specifically, the frame 102 is formed of any suitable material that provides for rigidity and durability, non-limiting examples of which include being formed of aluminum, plastic, iron, wood, carbon fiber, fiberglass and foam.

Additionally, the frame 102 is formed of any suitable number of components that are connected with one another to be collapsible between the extended position 104 and collapsed position 106. As a non-limiting example, the frame 102 is formed of a first 108 half hingedly connected with a second half 110. Other non-limiting examples include being formed of three components hingedly connected to form a tri-panel configuration or each of the halves further formed of two or more collapsible components. Each of the components (e.g., first half 108 and second half 110) are connected with each other using any suitable mechanism or device to enable the collapsibility of the frame 102, a non-limiting example of which includes using a hinge 112 to hingedly connect each of the components.

As can be appreciated by one skilled in the art, the template 100 operates as a mask to shield a portion of a ground surface and define an opening 112 when placed upon the ground surface. The opening 112 is used to allow a user to paint the ground surface and generate a marking that is defined by the mask (i.e., template 100). As applied to the present invention, in the extended position 104, the frame 102 defines a substantially rectangular-shaped opening 114 to allow a user to paint a substantially rectangular-shape upon the ground surface.

When in the extended position 104, the substantially rectangular-shaped opening 114 is defined by two long legs 116A and 116B and two short legs 118A and 118B. Each long leg 116A or 116B has a long leg length 120 that is formed by the two halves 108 and 110. Additionally, a center point 124 exists along the length 120 of each of the two long legs 116A and 116B, with the center point 124 delimiting the first half 108 from the second half 110. Further, each short leg 118A and 118B has a short leg length 122.

In operation, in many circumstances, it is desirable to paint an “X” or cross upon the ground surface. The “X” or cross is readily identifiable by an airborne operator and is commonly used to mark landmarks for land surveyors and others. While the present invention generally allows a user to paint a rectangular shape upon the ground surface, it can be further used to create two overlapping and substantially perpendicular rectangular shapes that operate to collectively form the “X” or cross.

In order to assist the user in creating such a shape, two markers 126A and 126B are formed on each of the long legs 116A and 11B. Each marker 126A and 126B is positioned along the long leg 116A or 116B and away from the center point 124 such that a distance 128 from the center point 124 to each marker 126A or 126B is approximately one half of the short leg length 122. Thus, when in the extended position 104, a distance 130 between the two markers 126A and 126B is approximately the same as the short leg length 122.

For further illustration, FIG. 2 depicts the template 100 being used to paint a first substantially rectangular-shape 200 upon a ground surface. The markers 126A and 126B are formed such that when a user paints 201 the first substantially rectangular-shape 200 upon the ground surface, the markers 126A and 126B cause distinct markings 202 upon the ground surface.

Thus, as depicted in FIG. 3, a user can use the template 100 to paint the first substantially rectangular-shape 200 upon a ground surface and then use the distinct markings 202 to align the two long legs 116A and 116B with the distinct markings 202. Once the two long legs 116A and 116B are aligned with the distinct markings 202, a user can use the template to paint 201 a second substantially rectangular-shape 300 upon the ground surface. Thus, the first 200 and second 300 substantially rectangular-shapes collectively form a cross upon the ground surface to operate as the aerial target.

Referring again to FIG. 1, although each of the legs 116A, 116B, 118A, and 118B are depicted as being substantially straight to collectively form the substantially rectangular opening 114, it should be understood that the present invention is not intended to be limited thereto and can be applied to a variety of shapes. For example, each of the legs can be formed such that they individually resemble an arc (not illustrated) and collectively form a semi-circle on each of the first and second halves. Thus, in this example. The first and second halves would collectively form a figure-eight shape when in the expanded position. Therefore, as can be appreciated by one skilled in the art, the present invention can be applied to a variety of shapes to allow a user to mark a ground surface and create an aerial target.

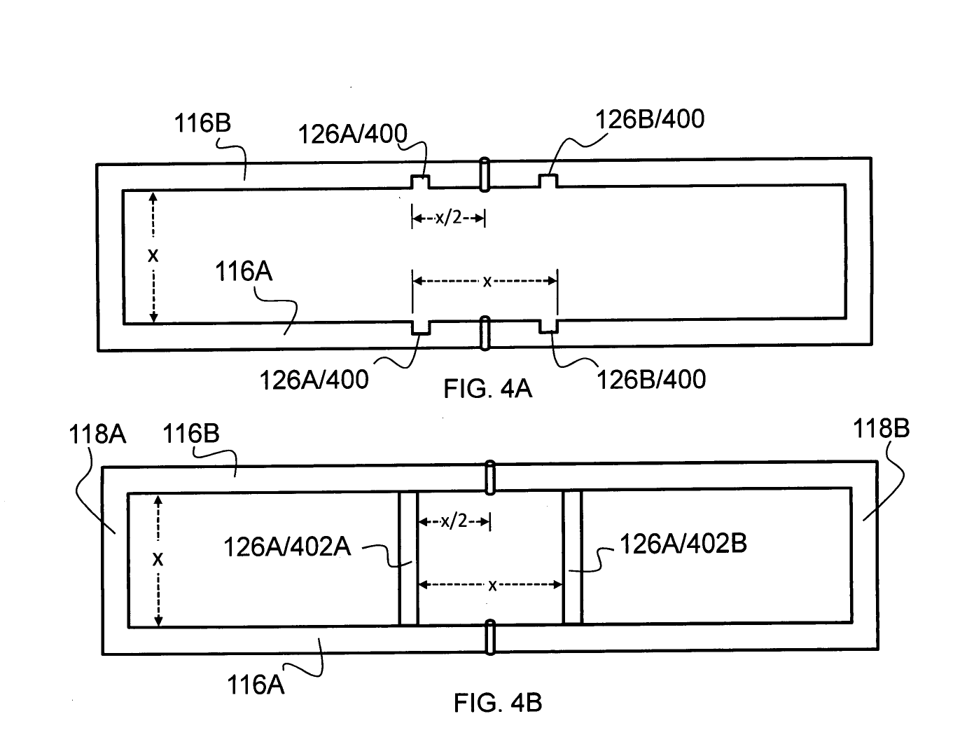

It should also be noted that the marker can be formed in any suitable shape and manner to effectively form a distinct marking upon the ground surface (when the ground surface is painted using the template 100). For example and as depicted in FIGS. 1 through 3, the marker 126A and 126B can be formed as a protrusion along the long legs 116A and 116B (thereby masking the ground surface when the ground surface is painted). The protrusion is formed in any suitable manner, non-limiting examples of which include being formed as an added piece to the frame or as wield residue that is formed when wielding the hinge 112 to each of the first 108 and second 110 halves. As another non-limiting example and as depicted in FIG. 4A, each marker 126A and 126B can be formed as a notch 400 along the long legs 116A and 116B. As yet another non-limiting example and as depicted in FIG. 4B, each marker 126A and 126B can be formed as a bar 402A and 402B positioned perpendicular to the short legs 118A and 118B and connecting the two opposing long legs 116A and 116B. Thus, as can be appreciated by one skilled in the art, the markers 126A and 126B can be formed in a variety of ways to allow for the formation of the distinct markings.

What is claimed is:

1. An aerial target template, comprising:
a substantially rigid frame, the frame being foldable from a collapsed position to an extended position; and
wherein in the extended position, the frame defines a substantially rectangular-shaped opening, the opening operating as a template to allow a user to paint a substantially rectangular-shape upon a ground surface.

2. An aerial target template as set forth in claim 1, wherein when in the extended position, the substantially rectangular-shaped opening is defined by two long legs and two short legs, each long leg having a long leg length and each short leg having a short leg length, and wherein a center point exists along the length of each of the two long legs.

3. An aerial target template as set forth in claim 2, further comprising two markers formed on each of the long legs, the markers formed such that when a user paints a first substantially rectangular-shape upon a ground surface, the markers cause distinct markings upon the ground surface.

4. An aerial target template as set forth in claim 3, wherein each marker is positioned along the long leg and away from the center point such that a distance from the center point to each marker is approximately one half of the short leg length, wherein when in the extended position, a distance between the two markers is approximately the same as the short leg length, whereby a user can use the template to paint the first substantially rectangular-shape upon a ground surface and then use the distinct markings to align the two long legs with the distinct markings and paint a second substantially rectangular-shape upon the ground surface, with the first and second substantially rectangular-shapes collectively forming a cross upon the ground surface to operate as the aerial target.

5. An aerial target template as set forth in claim 4, wherein the frame is formed of a first half hingedly connected with a second half, with the center point delimiting the first half from the second half.

6. An aerial target template as set forth in claim 5, wherein the frame is formed of a material selected from a group consisting of aluminum, plastic, iron, wood, carbon fiber, fiberglass and foam.

7. An aerial target template as set forth in claim 6, wherein the marker is selected from a group consisting of a protrusion along the long leg, a notch along the long leg, and a bar positioned perpendicular to the short leg and connecting two opposing long legs.

8. An aerial target template as set forth in claim 3, wherein the marker is selected from a group consisting of a protrusion along the long leg, a notch along the long leg, and a bar positioned perpendicular to the short leg and connecting two opposing long legs.

9. An aerial target template as set forth in claim 2, wherein the frame is formed of a first half hingedly connected with a second half, with the center point delimiting the first half from the second half.

10. An aerial target template as set forth in claim 1, wherein the frame is formed of a material selected from a group consisting of aluminum, plastic, iron, wood, carbon fiber, fiberglass and foam.

11. A method for marking a ground surface using an aerial target template to form an aerial target, comprising acts of:
unfolding a substantially rigid frame from a collapsed position to an extended position to define a substantially rectangular-shaped opening, the opening operating as a template to allow a user to paint a substantially rectangular-shape upon a ground surface;
positioning the template upon the ground surface; and
painting the ground surface through the defined substantially rectangular-shaped opening to form a first substantially rectangular-shape upon the ground surface.

12. A method as set forth in claim 11, wherein in the act of painting the ground surface, the ground surface is painted such that distinct markings exist upon the ground surface.

13. A method as set forth in claim 12, further comprising acts of:
aligning the substantially rigid frame with the distinct markings; and
painting a second substantially rectangular-shape upon the ground surface such that the first and second substantially rectangular-shapes collectively form a cross upon the ground surface to operate as the aerial target.
